(19) United States
(12) Patent Application Publication
(10) Pub. No.: US 2005/0167865 A1
(43) Pub. Date: Aug. 4, 2005

(54) Multilayer optical recording medium manufacturing method and multilayer optical recording system

(76) Inventors: Tetsuro Mizushima, Tokyo (JP); Tsuyoshi Komaki, Tokyo (JP); Jiro Yoshinari, Tokyo (JP)

Correspondence Address: GREENBLUM & BERNSTEIN, P.L.C., 1950 ROLAND CLARKE PLACE, RESTON, VA, 20191, US

(21) Appl. No.: 10/498,976

(22) PCT Filed: Dec. 26, 2002
(86) PCT No.: PCT/JP02/13722

(30) Foreign Application Priority Data
Dec. 27, 2001 (JP) 2001-396075

(51) Int. Cl. B29D 17/00

(52) U.S. Cl. 264/1.33; 430/320; 430/321

(57) ABSTRACT

A method of manufacturing a multilayer optical recording medium fabricates a first stamper made of metal and a resin stamper in which a fine protrusion/depression pattern is formed, the fine protrusion/depression pattern of the resin stamper being formed by transferring a pattern from a metal stamper, being deeper than a reversed fine protrusion/depression pattern of the first stamper, and being capable of forming, in one surface of a spacer layer, guide grooves of equal depth to guide grooves formed in one surface of a substrate. By transferring a pattern from the first stamper, the substrate that has guide grooves formed in one surface is fabricated. A recording layer is formed on a surface of the guide grooves of the substrate and a light transmitting resin is applied onto the surface of the recording layer. A pattern is transferred from the resin stamper to the surface of the light transmitting resin to form the spacer layer in which guide grooves of equal depth to the guide grooves formed in the substrate are formed, and the recording layer is formed on the surface of the guide grooves of the spacer layer.

### TECHNICAL FIELD

The present invention relates to a method of manufacturing a multilayer optical recording medium including a substrate that has guide grooves for tracking purposes formed on a surface thereof on an incident side for a laser beam, the guide grooves having a recording layer formed on a surface thereof, and a light transmitting layer that also has guide grooves for tracking purposes formed in a surface thereof, the guide grooves having another recording layer formed on a surface thereof and the light transmitting layer being formed above the substrate, and also relates to a multilayer optical recording medium.

### BACKGROUND ART

As one example of this type of multilayer optical recording medium, a multilayer optical recording medium 31 (which as one example has two layers) shown in FIG. 18 is known. This multilayer optical recording medium 31 is a so-called “single-sided multilayer optical recording medium”, and is constructed of a recording layer L1, a spacer layer SP, a recording layer L0, and a cover layer C that are formed in layers in the stated order on a substrate D in the form of a flat plate (as one example, in a disc shape) that has an attachment center hole formed in a center part. In this case, a fine protrusion/depression pattern (with a depth Ld12) of guide grooves (grooves GR, lands LD, and the like) is formed in the cover layer C-side surface of the substrate D. The recording layer L1 is provided on this fine protrusion/depression pattern and is composed of laminated layers, such as a reflective film that reflects a recording laser beam and a reproduction laser beam (hereinafter referred to as the “laser beam” when distinction is not required), a phase change film whose light reflectivity changes in accordance with changes in the optical constant due to irradiation with a recording laser beam, and a protective film that protects the phase change film. The spacer layer SP is formed of a light transmitting resin, and has a fine protrusion/depression pattern of grooves GR, lands LD, and the like with a depth Ld02, which is equal to the depth Ld12 of the fine protrusion/depression pattern formed in the substrate D, formed in the surface on the cover layer C side. The recording layer L0 is composed of layers such as a phase change film and a protective film that are laminated on this fine protrusion/depression pattern. The cover layer C is formed of a light transmitting resin. By irradiating this multilayer optical recording medium 31 with a laser beam from an optical pickup in the direction of the arrow A in FIG. 18, the recording of data onto these recording layers L0, L1 or the reading of data from these recording layers L0, L1 is carried out.

Next, a method of manufacturing the multilayer optical recording medium 31 will be described with reference to FIGS. 14 to 18.

When manufacturing this multilayer optical recording medium 31, first a master stamper MSS that has a fine pattern (hereinafter referred to as an “inphase fine protrusion/depression pattern”) with the same orientation as the fine pattern of grooves GR, lands LD, pits, and the like (hereinafter referred to as the “grooves GR, lands LD, and the like”) to be formed in the surface of a substrate D is fabricated using a metal material. Next, as shown in FIG. 14, by transferring the fine protrusion/depression pattern formed in the surface of this master stamper MSS, a mother stamper MTS11, in whose surface a fine protrusion/depression pattern (hereinafter, “reversed fine protrusion/depression pattern”) with a reversed orientation (an orientation with reversed phase) to the fine protrusion/depression pattern of the grooves GR, lands LD, and the like is formed, is fabricated using a metal material. In this case, since the mother stamper MTS11 is fabricated of a metal material, the fine protrusion/depression pattern of the mother stamper MTS11 has the same depth DPMS11 as the fine protrusion/depression pattern of the master stamper MSS but a reversed orientation. In addition, as shown in FIG. 15, by transferring a pattern from the mother stamper MTS11, a child stamper CHS, in whose surface an inphase fine protrusion/depression pattern with the same orientation as the grooves GR, lands LD, and the like is formed, is fabricated using a metal material. In this case, since the child stamper CHS is fabricated of a metal material, the fine protrusion/depression pattern of the child stamper CHS has the same depth DPMS11 as the fine protrusion/depression pattern of the mother stamper MTS11 but a reversed orientation.

Next, as shown in FIG. 16, the mother stamper MTS11 and the child stamper CHS are respectively placed in resin-molding molds (not shown) and the substrate D and the cover layer C, in whose surfaces the grooves GR, the lands LD, and the like are formed, are fabricated by injecting resin materials into the respective molds. In this case, the cover layer C is fabricated using a light-transmitting resin material. Next, as shown in FIG. 17, the recording layer L1 is formed on the grooves GR, the lands LD, and the like of the fabricated substrate D and the recording layer L0 is formed on the surface of the fabricated cover layer C, in which the fine protrusion/depression pattern is formed. Finally, as shown in FIG. 18, the substrate D and the cover layer C are arranged with the respective surfaces, in which the fine protrusion/depression patterns are formed facing one another and are stuck together using an adhesive made of a light transmitting resin material. In this case, the adhesive layer formed by the light transmitting resin adhesive composes the spacer layer SP as a light transmitting layer. In this state, the recording layer L1 on the substrate D and the recording layer L0 on the cover layer C (on the spacer layer SP) have inphase fine protrusion/depression patterns with the same orientation with respect to the orientation of the incident light. Also, at the surface of the spacer layer SP that contacts the cover layer C, the adhesive that is yet to harden assumes the shape of the fine protrusion/depression pattern formed in the cover layer C so that a fine protrusion/depression pattern with a reversed orientation to the pattern of the cover layer C is formed. By the above process, the multilayer optical recording medium 31 is manufactured. It should be noted that although the widths of the respective grooves GR of the substrate D and the spacer layer SP shown in the drawings appear to be different, in reality the widths on both surfaces are substantially equal.

However, in this method of manufacturing, since the cover layer C is fabricated by injection molding, it is difficult to form the cover layer C with a narrow thickness, so that there is the problem that the thickness of the entire multilayer optical recording medium 31 is increased.

For this reason, the inventors have developed a method of manufacturing that can manufacture a multilayer optical recording medium 41 with a thin cover layer C. It should be noted that in the same way as the multilayer optical recording medium 31, the multilayer optical recording medium 41 is irradiated with a laser beam from an optical pickup in the direction of the arrow A as shown in FIG. 25 to record data on the recording layers L0, L1 or read data from the recording layers L0, L1. This method of manufacturing is described below with reference to FIGS. 19 to 25. It should be noted that the component parts that are the same as the multilayer optical recording medium 31 have been given the same reference numerals and redundant description of such has been omitted.

In this method of manufacturing, first a stamper fabricating process is carried out. In this process, in the same way as in the method of manufacturing the multilayer optical recording medium 31 described above, first a single master stamper MSS is fabricated and this master stamper MSS is used to fabricate the mother stamper MTS11 that is made of metal (see FIG. 14). In this case, the metal material has favorable transfer characteristics and a negligible rate of shrinkage, therefore in the mother stamper MTS11, a reversed fine protrusion/depression pattern is formed with a depth approximately equal to the depth DPMS11 of the fine protrusion/depression pattern in the master stamper MSS. Next, using the mother stamper MTS11, the child stamper CHS is fabricated using a metal material (see FIG. 15). In this case, in the same way as the mother stamper MTS11, the child stamper CHS is fabricated using a metal material, so that the inphase fine protrusion/depression pattern formed in the surface thereof is formed with a depth approximately equal to the depth DPMS11 of the fine protrusion/depression pattern of the master stamper MSS. Next, as shown in FIG. 19, this child stamper CHS is used to fabricate a stamper RS, in whose surface a reversed fine protrusion/depression pattern with the same orientation as the mother stamper MTS11 but a reversed orientation to the fine protrusion/depression pattern of the child stamper CHS is formed (transferred), using a light transmitting resin material (for example, an acrylic resin or an olefin resin). In this case, the transfer characteristics of the resin material are inferior to the transfer characteristics of the metal materials, and the rate of shrinkage (in this example, 0.5 to 1.5%) of the resin material is much higher than the rate of shrinkage (in this example, almost 0%) of the metal materials used in the plating process. For this reason, on the resin stamper RS, a depth DPRS11 of the fine protrusion/depression pattern formed in the surface thereof for forming the grooves GR, lands LD, and the like is shallower than the depth DPMS11 of the fine protrusion/depression pattern of the child stamper CHS.

Next, the method of manufacturing the multilayer optical recording medium 41 is carried out using the fabricated stampers. In this process, first, the mother stamper MTS11 is set inside a resin molding mold (not shown), and by injecting a resin material (for example, polycarbonate (PC)) inside the mold, as shown in FIG. 20, the substrate D, in whose surface the guide grooves (grooves GR, lands LD, and the like) are formed, is fabricated. In this case, since the rate of shrinkage of the PC used as the resin is 0.5 to 1.5%, the depth Ld13 of the fine protrusion/depression pattern of the substrate D is formed a corresponding amount shallower than the depth DPMS11 of the fine protrusion/depression pattern in the mother stamper MTS11. Next, as shown in FIG. 21, the recording layer L1 is formed by sputtering, for example, on the surface of the fabricated substrate D in which the fine protrusion/depression pattern has been formed.

Next, as shown in FIG. 22, an applied liquid R for a light transmitting resin is dripped onto the surface of the substrate D on which the recording layer L1 is formed and a thin layer of the applied liquid R is applied across the entire surface region of the substrate D by spin coating. Next, as shown in FIG. 23, the resin stamper RS is placed over the substrate D on which the applied liquid R has been applied in a state where the surface of the resin stamper RS in which the fine protrusion/depression pattern is formed faces the applied liquid R. In this case, when application on the substrate D is complete, the applied liquid R still exhibits fluidity and so assumes the shape of the fine protrusion/depression pattern formed in the surface of the resin stamper RS while spreading out within the entire gap between the resin stamper RS and the substrate D.

Next, the applied liquid R is hardened. More specifically, when a UV curable resin is used as the applied liquid R, the applied liquid R is irradiated with UV rays from the resin stamper RS side to harden the applied liquid R. At this time, in accordance with the transfer characteristics from the resin stamper RS to the spacer layer SP (due to factors such as the rate of shrinkage of the UV curable resin used and the contact pressure between the UV curable resin and the resin stamper), the depth Ld03 of the lands LD formed in the spacer layer SP is 2 to 10% shallower than the depth DPRS11 of the fine protrusion/depression pattern formed in the resin stamper RS. Next, as shown in FIG. 24, the resin stamper RS is separated from the substrate D. By doing so, the spacer layer SP, in whose surface the fine protrusion/depression pattern of grooves GR, lands LD, and the like has been formed (transferred), is completed. In this case, the grooves GR (guide grooves) of the substrate D are formed shallower in accordance with the rate of shrinkage of the polycarbonate used as the resin. On the other hand, in addition to the resin shrinking during the fabrication of the resin stamper RS so that the reversed fine protrusion/depression pattern of the resin stamper RS becomes shallow, the transfer characteristics from the resin stamper RS when forming the spacer layer SP cause the grooves GR of the spacer layer SP to be formed even shallower by a corresponding amount. Accordingly, even when the shrinkage of the resin during the fabrication of the substrate D and the shrinkage of the resin during the fabrication of the resin stamper RS are about the same, the lands LD of the spacer layer SP will still definitely be formed shallower than the depth Ld13 of the lands LD of the substrate D by an amount due to the transfer characteristics from the resin stamper RS.

Next, as shown in FIG. 25, the recording layer L0 is formed by sputtering, for example, on the surface of the formed spacer layer SP on which the fine protrusion/depression pattern has been formed. After this, the recording layer L0 is spin coated with an applied liquid and the applied liquid is hardened to form the cover layer C. By doing so, the manufacturing of the multilayer optical recording medium 41 is completed. According to this method of manufacturing, the cover layer C is fabricated by spin coating, so that the cover layer C can be formed with a narrower thickness than by methods that manufacture the cover layer C by resin molding.

### DISCLOSURE OF THE INVENTION

By investigating the multilayer optical recording medium 41 manufactured using the resin stamper RS described above, the present inventors discovered the following problem. That is, when the recording of data on the recording layers L0, L1 or the reading of data from the recording layers L0, L1 is carried out for the multilayer optical recording medium 41, a tracking servo is carried out using a tracking error signal outputted from an optical pickup that receives a laser beam that has been reflected by the respective recording layers L0, L1. In this case, the signal level of the tracking error signal is affected by the depth of the lands LD formed in the surfaces of the substrate D and the spacer layer SP, and in general, within a predetermined range, the signal level of the tracking error signal is higher the deeper the lands LD are formed. More specifically, the following relationship is established between the signal level Ip of the tracking error signal and the depth Ld of the lands LD.
Ip∝ sin (2Π·2·n·Ld/λ)

Here, n represents the refractive index of the cover layer C (or the spacer layer SP), and λ represents the laser beam wavelength.

On the other hand, for the multilayer optical recording medium 41, as described above, in a case where the shrinkage of the resin when fabricating the substrate D and the shrinkage of the resin when fabricating the resin stamper RS are approximately equal, the depth Ld03 of the lands LD of the spacer layer SP are definitely formed shallower than the depth Ld13 of the lands LD of the substrate D by an amount caused by the transfer characteristics from the resin stamper RS. This means that for the multilayer optical recording medium 41, it is harder to carry out a tracking servo for the recording layer L0 than a tracking servo for the recording layer L1, so that there is the problem that it may not be possible to favorably carry out the recording of data on the recording layer L0 and the reading of data from the recording layer L0.

The present invention was conceived in view of the problem described above, and it is a principal object of the present invention to provide a method of manufacturing a multilayer optical recording medium for which data can be favorably recorded and read on the respective recording layers and which can be formed with a narrow overall thickness. It is a further object to provide a multilayer optical recording medium for which data can be favorably recorded and read on the respective recording layers without increasing the overall thickness.

A method of manufacturing a multilayer optical recording medium according to the present invention uses a stamper fabricated by a stamper fabricating step to manufacture a multilayer optical recording medium including a substrate that has guide grooves for tracking purposes formed on a surface thereof on an incident side for a laser beam, the guide grooves having a recording layer formed on a surface thereof, and a light transmitting layer that also has guide grooves for tracking purposes formed in a surface thereof, the guide grooves having another recording layer formed on a surface thereof and the light transmitting layer being formed above the substrate, the stamper fabricating step including at least a step of fabricating a first stamper, which is made of metal and in whose surface a reversed fine protrusion/depression pattern with a reversed orientation to a protrusion/depression pattern of the guide grooves is formed, and a resin stamper in whose surface is formed a reversed fine protrusion/depression pattern, the reversed fine protrusion/depression pattern of the resin stamper being transferred from a metal stamper in whose surface is formed a fine protrusion/depression pattern with the same orientation as the protrusion/depression pattern of the guide grooves, having a reversed orientation to the guide grooves, having a depth that is deeper than the reversed fine protrusion/depression pattern of the first stamper, and being capable of forming, when the resin stamper is used to form the light transmitting layer, guide grooves of an equal depth or an approximately equal depth to the guide grooves formed in the surface of the substrate in a surface of the light transmitting layer, and the method of manufacturing comprising at least: as an intermediate step of manufacturing the multilayer optical recording medium, a step of fabricating the substrate, in whose surface the guide grooves are formed by transferring a pattern from the first stamper; a step of forming the recording layer on the surface of the guide grooves in the fabricated substrate; a step of applying a light transmitting resin onto the surface of the formed recording layer; a step of forming the light transmitting layer, in which the guide grooves are formed with an equal or approximately equal depth to the guide grooves formed in the substrate, by transferring a pattern from the resin stamper to the surface of the applied light transmitting resin; and a step of forming the other recording layer on the surface of the guide grooves in the formed light transmitting layer.

According to this method of manufacturing a multilayer optical recording medium, the stamper fabricating step includes at least a step of fabricating a first stamper, which is made of metal and in whose surface a reversed fine protrusion/depression pattern with a reversed orientation to a protrusion/depression pattern of the guide grooves to be formed in the surfaces of the substrate and the light transmitting layer is formed, and a resin stamper in whose surface is formed a reversed fine protrusion/depression pattern, the reversed fine protrusion/depression pattern of the resin stamper being transferred from a metal stamper in whose surface is formed a fine protrusion/depression pattern with the same orientation as the protrusion/depression pattern of the guide grooves, having a reversed orientation to the guide grooves, having a depth that is deeper than the reversed fine protrusion/depression pattern of the first stamper, and being capable of forming, when the resin stamper is used to form the light transmitting layer, guide grooves of an equal depth or an approximately equal depth to the guide grooves formed in the surface of the substrate in the surface of the light transmitting layer. By respectively forming the substrate and the light transmitting layer using the first stamper and the resin stamper, the depth of the guide grooves of the light transmitting layer and the depth of the guide grooves of the substrate can be made similar, so that it is possible to manufacture a multilayer optical recording medium for which a favorable S/N ratio can be achieved for the tracking error signal during a tracking servo for every recording layer. Also, according to this method of manufacturing, by forming a cover layer by spin coating an applied liquid on a recording layer and hardening the applied liquid, it is possible to reduce the thickness of the cover layer, so that the multilayer optical recording medium can also be made thinner.

A multilayer optical recording medium according to the present invention is manufactured in accordance with the method of manufacturing a multilayer optical recording medium described above and includes the substrate that has the guide grooves for tracking purposes formed on the surface thereof on the incident side for a laser beam, the guide grooves having the recording layer formed on the surface thereof, and at least one light transmitting layer that also has guide grooves for tracking purposes formed in a surface thereof, the guide grooves having another recording layer formed on a surface thereof and the at least one light transmitting layer being formed above the substrate, wherein the guide grooves respectively formed in the respective surfaces of the substrate and the light transmitting layer are formed with equal or approximately equal depths.

With the multilayer optical recording medium according to the present invention, by making the depths of the guide grooves formed in the respective surfaces of the light transmitting layer and the substrate equal or approximately equal, the signal level for the tracking error signal during a tracking servo for the recording layer formed on the surface of the light transmitting layer can be kept at the same high level as the signal level for the tracking error signal during a tracking servo for the recording layer formed on the surface of the substrate. Accordingly, since it is possible to improve the S/N ratio of the tracking error signal outputted from the optical pickup during a tracking servo on the recording layer formed on the light transmitting layer, it is possible to favorably carry out a tracking servo on the recording layer formed on the light transmitting layer in the same way as a tracking servo on the recording layer formed on the substrate. Accordingly, the recording of data on every recording layer and the reading of data from every recording layer can be carried out favorably.

It should be noted that although in the intermediate step of the method of manufacturing described above for the multilayer optical recording medium according to the present invention, the light transmitting layer that has guide grooves for tracking purposes formed in a surface thereof, the guide grooves having a recording layer formed on a surface thereof, is formed by a single resin layer fabricated by carrying out a step of applying a light transmitting resin onto the surface of the recording layer formed on the substrate and a step of forming the light transmitting layer, in which the guide grooves are formed, by transferring a pattern from the resin stamper to a surface of the applied light transmitting resin, it is also possible to form the light transmitting layer of two or more resin layers using the substrate and the resin stamper used in the steps described above. The method of manufacturing the light transmitting layer in this case carries out at least a step of forming a light transmitting layer (the first layer), in which the guide grooves are formed, by applying the light transmitting resin onto the resin stamper and transferring a pattern from the resin stamper to the surface of the light transmitting resin, a step of applying a light transmitting adhesive resin (the second layer) onto the recording layer formed on the substrate, and a step of sticking together (attaching) the substrate and the light transmitting layer, in which the guide grooves are formed, with the respective resins facing each other.

It should be noted that the disclosure of the present invention relates to a content of Japanese Patent Application 2001-396075 that was filed on 27 Dec. 2001 and the entire content of which is herein incorporated by reference.

### BRIEF DESCRIPTION OF THE DRAWINGS

FIG. 1 is a side cross-sectional view of a first mother stamper MTS1.

FIG. 2 is a side cross-sectional view of a child stamper CHS2.

FIG. 3 is a side cross-sectional view of when a resin stamper RS is fabricated from the child stamper CHS2.

FIG. 4 is a side cross-sectional view of when a substrate D is fabricated using the first mother stamper MTS1.

FIG. 5 is a side cross-sectional view of the substrate D on whose surface a recording layer L1 has been formed.

FIG. 6 is a side cross-sectional view of a state where an applied liquid R has been applied onto the substrate D by spin coating.

FIG. 7 is a side cross-sectional view of a state where the resin stamper RS has been placed on the substrate D on which the applied liquid R has been applied.

FIG. 8 is a side cross-sectional view of a state where a spacer layer SP has been fabricated by hardening the applied liquid R and then separating the resin stamper RS.

FIG. 9 is a side cross-sectional view showing the construction of a multilayer optical recording medium 1.

FIG. 10 is a side cross-sectional view of a state where, in another fabrication process for the spacer layer SP, an applied liquid R1 has been applied onto the resin stamper RS by spin coating and then hardened.

FIG. 11 is a side cross-sectional view of a state where, in another fabrication process for the spacer layer SP, an applied liquid R2 has been applied onto the substrate D by spin coating.

FIG. 12 is a side cross-sectional view of a state where the resin stamper RS shown in FIG. 10 has been placed on the substrate D in the state shown in FIG. 11 and the applied liquid R2 has been hardened.

FIG. 13 is a side cross-sectional view of a state where the spacer layer SP has been fabricated by separating the resin stamper RS from the state shown in FIG. 12.

FIG. 14 is a side cross-sectional view of when the mother stamper MTS11 is fabricated from the master stamper MSS.

FIG. 15 is a side cross-sectional view of when the child stamper CHS is fabricated from the mother stamper MTS11.

FIG. 16 is a pair of side cross-sectional views of when the substrate D is fabricated from the mother stamper MTS11 and when a cover layer C is fabricated from the child stamper CHS.

FIG. 17 is a pair of side cross-sectional views of a state where the recording layer L1 is formed on the surface of the substrate D and a state where the recording layer L0 is formed on the surface of the cover layer C.

FIG. 18 is a side cross-sectional view showing the construction of a multilayer optical recording medium 31.

FIG. 19 is a cross-sectional view of when the resin stamper RS is fabricated from the child stamper CHS.

FIG. 20 is a side cross-sectional view of when the substrate D is fabricated using the mother stamper MTS11.

FIG. 21 is a side cross-sectional view of the substrate D in whose surface the recording layer L1 has been formed.

FIG. 22 is a side cross-sectional view of a state where the applied liquid R has been applied on the substrate D by spin coating.

FIG. 23 is a side cross-sectional view of a state where the resin stamper RS has been placed on the substrate D, on whose surface the applied liquid R has been applied.

FIG. 24 is a side cross-sectional view of a state where after the applied liquid R has been hardened, the resin stamper RS has been separated to fabricate the spacer layer SP.

FIG. 25 is a side cross-sectional view showing the construction of the multilayer optical recording medium 41.

### BEST MODE FOR CARRYING OUT THE INVENTION

Preferred embodiments of a multilayer optical recording medium and a multilayer optical recording medium manufacturing method according to the present invention will now be described with reference to the attached drawings.

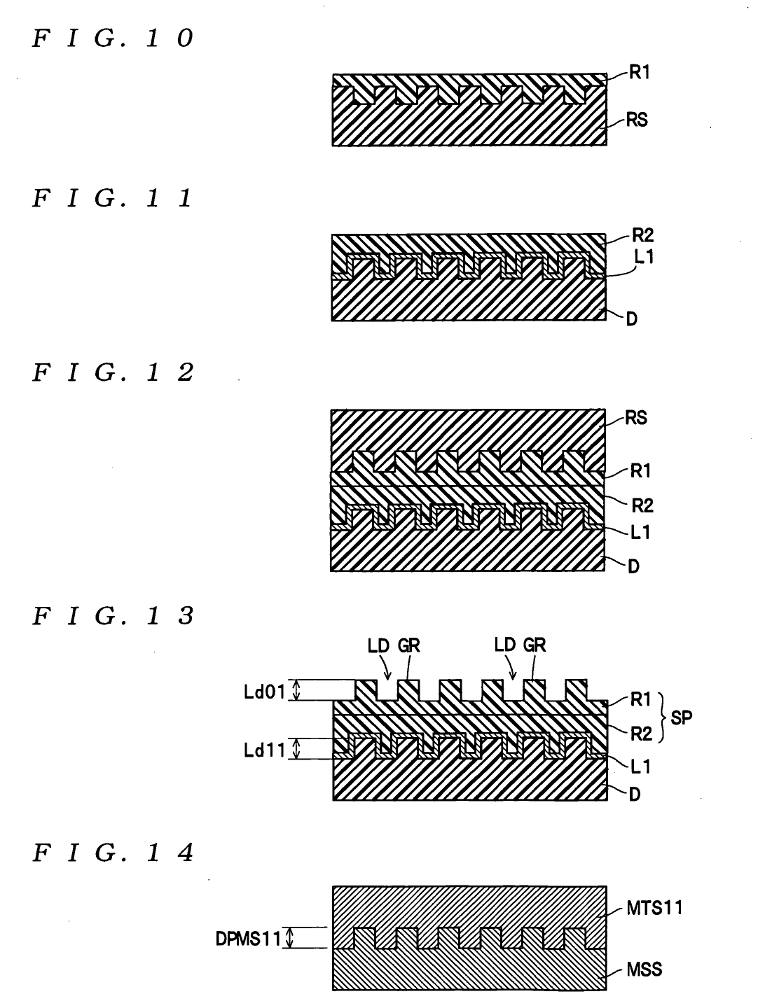

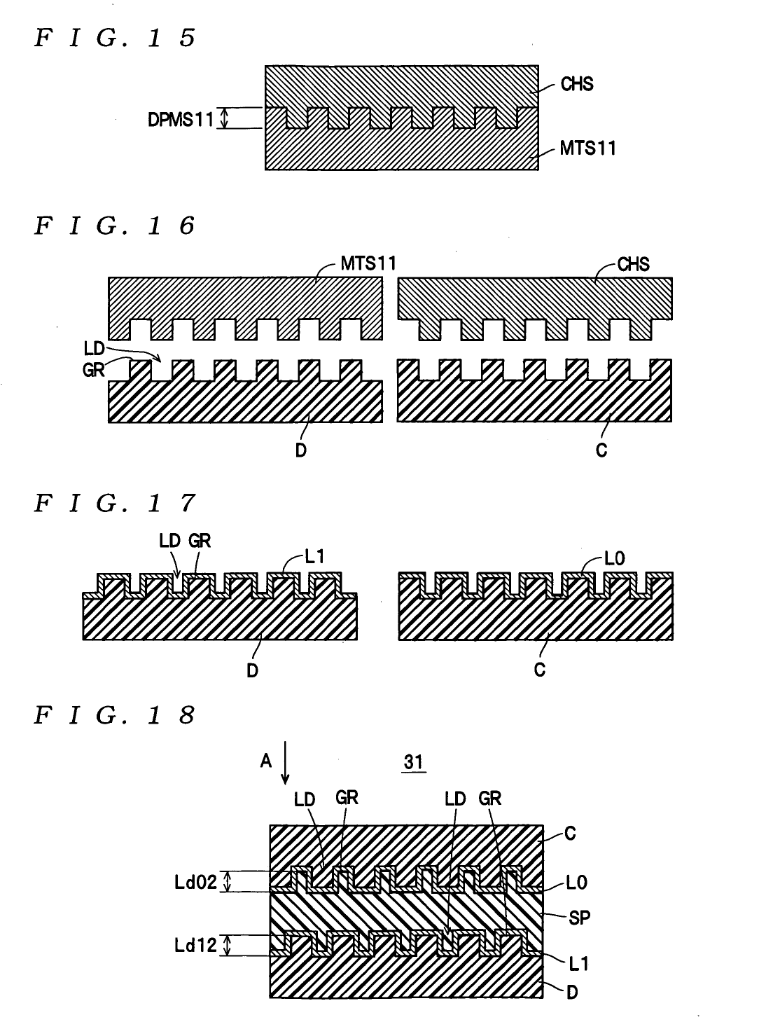

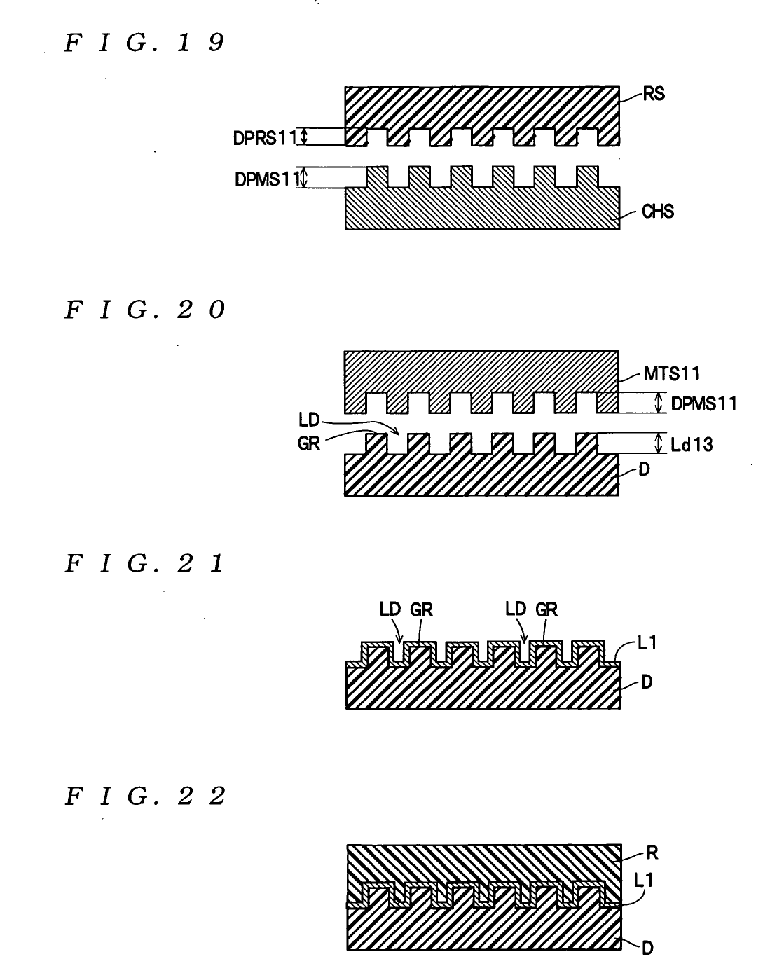

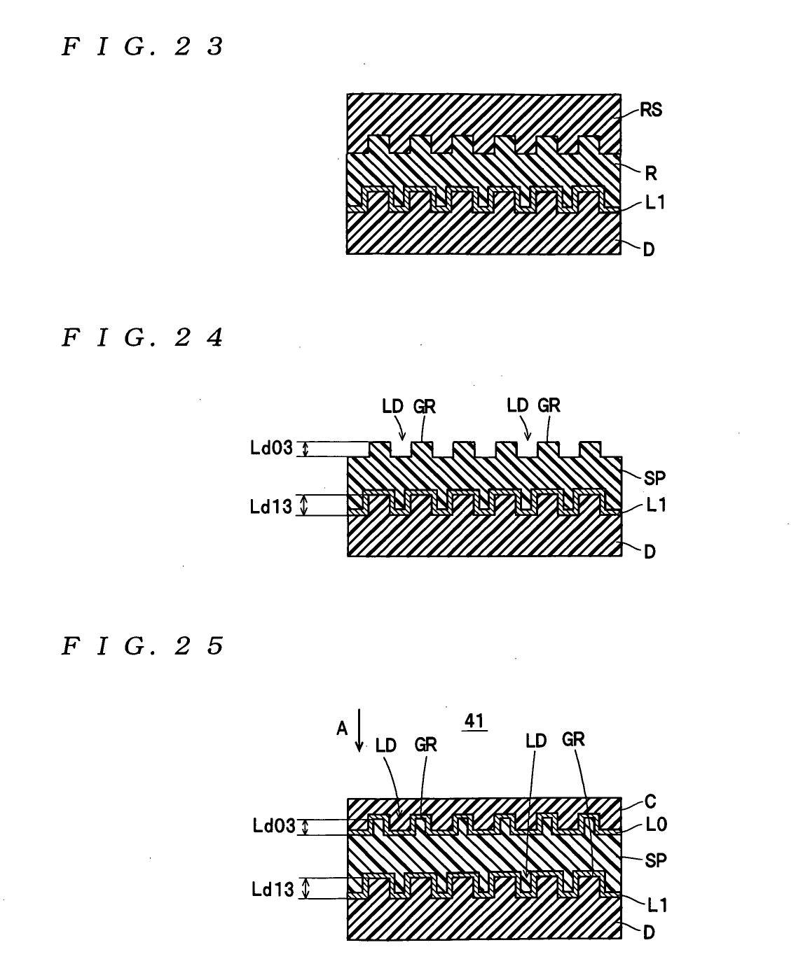

First, the construction of a multilayer optical recording medium 1 (as one example, a two-layer medium) will be described with reference to FIG. 9.

The multilayer optical recording medium 1 is a so-called single-sided multilayer optical recording medium (a rewritable optical recording medium) with a plurality of phase-change recording layers, for example, and is composed of at least a substrate D, a recording layer L1, a spacer layer SP, a recording layer L0, and a cover layer C. The substrate D is formed in a plate-like shape (as one example, a disc shape) with resin (for example, polycarbonate) as the material. On one surface of the substrate D (the upper surface in FIG. 9), grooves GR, lands LD, and the like for guiding a laser beam are formed in spirals as a fine protrusion/depression pattern from a central periphery of the substrate D towards an outer edge. Also, to obtain a tracking error signal with a favorable S/N ratio during a tracking servo, the depth Ld11 of the lands LD formed in this substrate D is set similar to (hereinafter, this means “equal to or approximately equal to”) the depth Ld12, Ld13 of the lands LD formed in the surface of the substrate D of the multilayer optical recording media 31, 41 described above. The recording layer L1 is composed by forming a reflective film, a phase change film, a protective film, and the like in layers above the grooves GR, lands LD, and the like formed in the surface of the substrate D. In this case, the phase change film is formed of a thin film of a phase change material such as GeTeSb, InSbTe, or AgGeInSbTe, deposited by sputtering, for example.

The spacer layer SP is formed of a light transmitting resin, and has grooves GR, lands LD, and the like formed in a cover layer C-side surface thereof. In this case, the depth Ld01 of the lands LD formed in the spacer layer SP is set similar to the depth Ld11 of the lands LD formed in the surface of the substrate D so that a tracking error signal with a favorable S/N ratio is obtained during a tracking servo. The recording layer L0 is composed by laminating a phase change film, a protective film, and the like above the grooves GR, lands LD, and the like formed in the surface of the spacer layer SP. In this case, the phase change film of the recording layer L0 is formed of the same construction as the phase change film of the recording layer L1. The cover layer C is a layer that protects the recording layer L0 from scratches and also acts as part (a lens) of an optical path, and is formed by spin coating the recording layer L0 with an applied liquid RC for a light transmitting resin and hardening the applied liquid RC. With this multilayer optical recording medium 1, the recording layers L1, L0 are irradiated in the direction shown by the arrow A in FIG. 9 by a laser beam (for example, a laser beam with a wavelength of 405 nm) generated by an optical pickup to reversibly cause phase changes between an amorphous state and a crystal state so that recording marks are recorded and erased. More specifically, when the recording layers L1, L0 are irradiated with a recording laser beam, the irradiated parts are heated to the melting point or above and then cooled (rapidly cooled) to enter an amorphous state, so that recording marks are formed in accordance with binary recording data. Also, when irradiation is carried out with the recording laser beam, irradiated parts of the recording layers L1, L0 are heated to the crystallization temperature or above and then cooled (gradually cooled) so as to be crystallized, thereby deleting the recording marks. In addition, by carrying out irradiation in the direction of the arrow A in FIG. 9 with a reproduction laser beam emitted from the optical pickup, data is read from the recording layers L0, L1.

In this way, with the multilayer optical recording medium 1, by making the depth Ld01 of the lands LD of the spacer layer SP similar to the depth Ld11 of the lands LD of the substrate D, it is possible to maintain a higher signal level for the tracking error signal during a tracking servo for the recording layer L0. Since it is possible to improve the S/N ratio of the tracking error signal outputted from the optical pickup during a tracking servo for the recording layer L0, it is possible to favorably carry out a tracking servo for the recording layer L0 in the same way as a tracking servo for the recording layer L1. Accordingly, it is possible to favorably record data onto and to read data from the respective recording layers L0, L1. Also, since the cover layer C is formed by spin coating the recording layer L0 with an applied liquid and hardening the applied liquid, compared to a multilayer optical recording medium 31, in which the cover layer C is fabricated by injection molding, the thickness of the cover layer C can be reduced, so that the overall thickness of the multilayer optical recording medium 1 can be reduced.

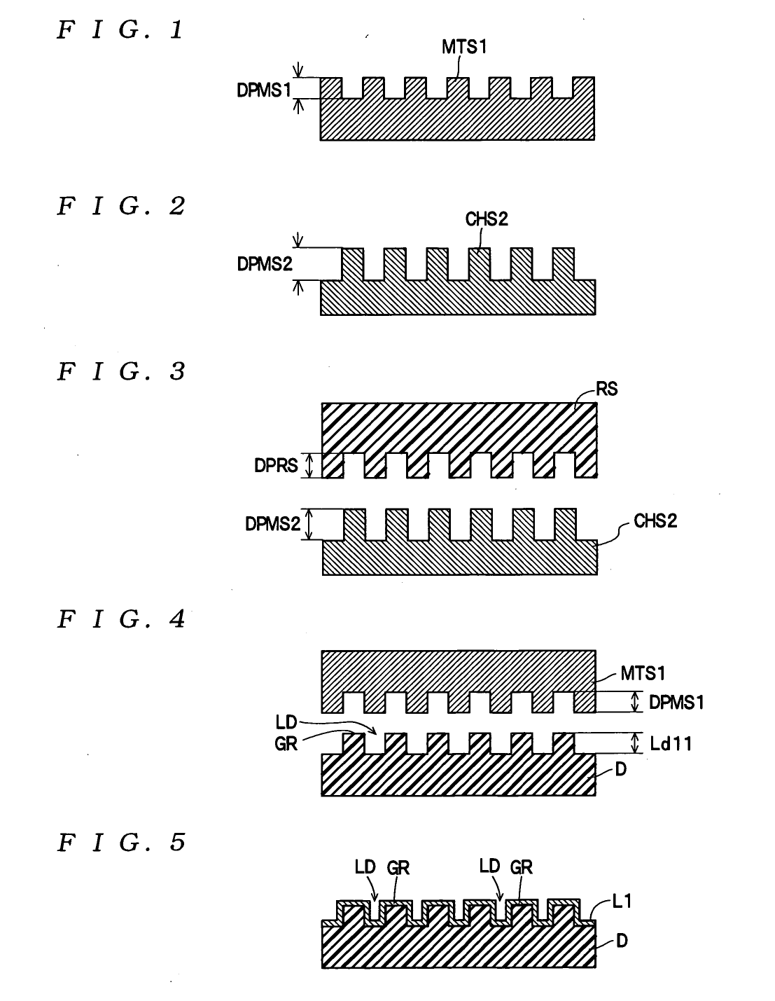

Next, a method of manufacturing the multilayer optical recording medium 1 will be described with reference to FIG. 1 to FIG. 9.

First, when manufacturing the multilayer optical recording medium 1, a “stamper fabricating step” for the present invention is carried out. In this process, first, a first master stamper (not shown), which has an inphase fine protrusion/depression pattern with the same orientation as the fine protrusion/depression pattern of the grooves GR, lands LD, and the like to be formed in the surface of the substrate D, is fabricated by carrying out a cutting process on a surface of a flat metal plate (as one example, a metal disc). It should be noted that it is possible to use the following method when fabricating the first master stamper. A resist layer is formed on the surface of a flat plate made of glass and an exposure/developing process (a patterning process) is carried out on this resist layer to form a reversed fine protrusion/depression pattern, which has a reversed orientation to the fine protrusion/depression pattern of the grooves GR, the lands LD, and the like in the surface of the flat glass plate. A metal layer is then formed by a metal plating process on the surface of the flat glass plate in which this reversed fine protrusion/depression pattern has been formed. This metal layer is then separated from the flat glass plate to fabricate the first master stamper. Next, in the same way as the method of manufacturing the multilayer optical recording medium 31, a first mother stamper MTS1, which corresponds to a first stamper for the present invention, is fabricated as shown in FIG. 1 by transferring a pattern from the first master stamper. Also, by carrying out a cutting process on a surface of a flat metal plate (as one example, a metal disc), a second master stamper (not shown) with an inphase fine protrusion/depression pattern is fabricated. Next, by transferring a pattern from the second master stamper an even number of times, as shown in FIG. 2, a child stamper CHS2 with an inphase fine protrusion/depression pattern is fabricated. Additionally, as shown in FIG. 3, the child stamper CHS2 (or the second master stamper) is used to fabricate a resin stamper RS in whose surface a reversed fine protrusion/depression pattern is formed, and the resin stamper RS is used to form a fine protrusion/depression pattern of the grooves GR, lands LD, and the like in the surface of the spacer layer SP.

In this case, it is preferable for the S/N ratio of the tracking error signal outputted from an optical pickup during a tracking servo on the recording layer L0 of the multilayer optical recording medium 1 to be equal to the S/N ratio of the tracking error signal outputted from the optical pickup during a tracking servo on the recording layer L1. Accordingly, the depth Ld01 of the lands LD formed in the surface of the spacer layer SP of the multilayer optical recording medium 1 is set equal to (or approximately equal to) the depth Ld11 of the lands LD formed in the surface of the substrate D of the multilayer optical recording medium 1. On the other hand, when the multilayer optical recording medium 1 is manufactured, the resin stamper RS is used when forming the grooves GR of the spacer layer SP. In this case, when the resin stamper RS is fabricated from the second mother stamper MTS2, the resin stamper RS shrinks by a rate of shrinkage that is unique to the resin material used. Also, due to the transfer characteristics when fabricating the spacer layer SP from the resin stamper RS, the grooves GR are shallowly formed by a corresponding amount. On the other hand, as described above, the transfer characteristics of metal materials is favorable and the rate of shrinkage is also negligible, so that the respective fine protrusion/depression patterns of the first master stamper and the first mother stamper MTS1 are formed with approximately equal depths, and the respective fine protrusion/depression patterns of the second master stamper and the child stamper CHS2 are also formed with approximately equal depths. Accordingly, during the cutting process for the second master stamper, the rate of shrinkage of the resin stamper RS and the transfer characteristics from the resin stamper RS to the spacer layer SP are taken into consideration and the inphase fine protrusion/depression pattern is cut with the depth DPMS2 (which is similar to the depth of the reversed fine protrusion/depression pattern of the child stamper CHS2) so as to satisfy the conditions that the depth DPRS of the reversed fine protrusion/depression pattern of the resin stamper RS is deeper than the depth DPMS1 of the reversed fine protrusion/depression pattern of the first mother stamper MTS1 and the depth Ld01 of the lands LD formed in the surface of the spacer layer SP becomes equal to (or approximately equal to) the depth Ld11 of the lands LD formed in the surface of the substrate D. More specifically, machining is carried out so that the depth DPMS2 of the grooves in the fine protrusion/depression pattern is deeper than the depth DPMS1 of the reversed fine protrusion/depression pattern formed in the mother stamper MTS1 by around 0.5 to 5 nm, for example.

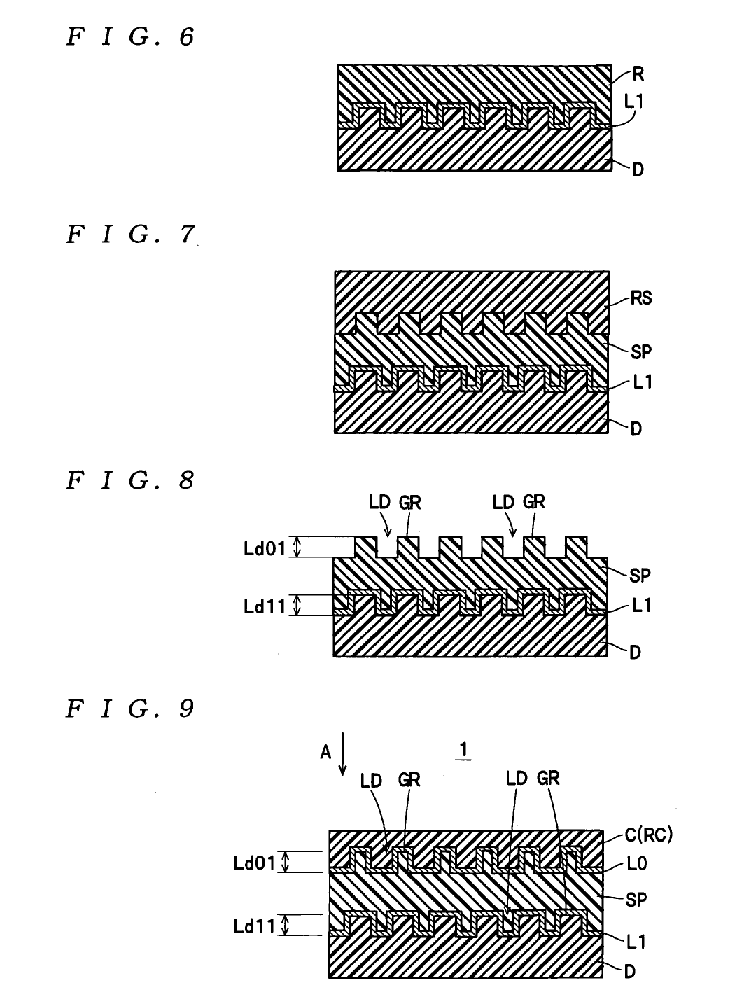

Next, the first mother stamper MTS1 is set in a resin molding mold and, as shown in FIG. 4, the substrate D, in whose surface guide grooves composed of the grooves GR, lands LD, and the like have been formed (transferred), is fabricated by injecting a resin material (for example, polycarbonate (PC)) into the mold. In this case, since the rate of shrinkage of the polycarbonate used as the resin is 0.5 to 1.5%, the depth Ld11 of the fine protrusion/depression pattern of the substrate D is formed a corresponding amount shallower than the depth DPMS1 of the reversed fine protrusion/depression pattern of the first mother stamper MTS1. Next, as shown in FIG. 5, the recording layer L1 is formed on the surface of the fabricated substrate D, in which the fine protrusion/depression pattern is formed, by sputtering, for example.

Next, as shown in FIG. 6, an applied liquid R for a light transmitting resin is dripped onto the surface of the substrate D on which the recording layer L1 has been formed and spin coating is carried out to apply a thin film of the applied liquid R across the entire surface region of the substrate D. Next, as shown in FIG. 7, the resin stamper RS is placed over the substrate D on which the applied liquid R has been applied with the surface of the resin stamper RS on which the fine protrusion/depression pattern is formed facing the applied liquid R. In this case, when the application on the substrate D is complete, the applied liquid R still exhibits fluidity and so assumes the shape of the fine protrusion/depression pattern of the surface of the resin stamper RS while spreading out within the entire gap between the resin stamper RS and the substrate D.

Next, the applied liquid R is hardened. More specifically, when a UV curable resin is used as the applied liquid R, the applied liquid R is irradiated with UV rays from the resin stamper RS side to harden the applied liquid R. At this time, in accordance with the transfer characteristics from the resin stamper RS to the spacer layer SP (due to factors such as the rate of shrinkage of the UV curable resin used and the contact pressure between the UV curable resin and the resin stamper), the depth Ld01 of the lands LD formed in the spacer layer SP is 2 to 10% shallower than the depth DPRS (see FIG. 3) of the fine protrusion/depression pattern formed in the resin stamper RS. In this case, the depth DPRS of the reversed fine protrusion/depression pattern of the resin stamper RS is formed deeper than the depth DPMS1 of the reversed fine protrusion/depression pattern of the first mother stamper MTS1 in advance in consideration of the transfer characteristics from the resin stamper RS to the spacer layer SP described above. As a result, the depth Ld01 of the lands LD formed in the spacer layer SP is formed similar to the depth Ld11 of the lands LD formed in the substrate D (see FIG. 8). Next, as shown in FIG. 8, the resin stamper RS is separated from the substrate D. By doing so, the spacer layer SP, in whose surface a fine protrusion/depression pattern of the grooves GR, lands LD, and the like has been formed (transferred), is completed.

Next, as shown in FIG. 9, the recording layer L0 is formed on the surface of the formed spacer layer SP, in which the fine protrusion/depression pattern has been formed, by sputtering, for example. The process thus far corresponds to an intermediate step for the present invention. After this, the cover layer C is formed by spin coating the recording layer L0 with an applied liquid RC and hardening the applied liquid RC. By doing so, the manufacturing of the multilayer optical recording medium 1 is completed.

In this way, according to this method of manufacturing a multilayer optical recording medium, the depth DPRS of the reversed fine protrusion/depression pattern of the resin stamper RS is formed deeper than the depth DPMS1 of the reversed fine protrusion/depression pattern of the first mother stamper MTS1 in advance in consideration of the transfer characteristics from the resin stamper RS to the spacer layer SP, so that the depth Ld01 of the lands LD of the spacer layer SP can be made similar to the depth Ld11 of the lands LD of the substrate D. Also, by forming the cover layer C by spin coating the recording layer L0 with the applied liquid R1 and then hardening the applied liquid R1, it is possible to manufacture a multilayer optical recording medium 1 in which the thickness of the cover layer C and in turn the overall thickness of the medium are reduced.

It should be noted that the present invention is not limited to the above embodiment, and can be modified as appropriate. For example, it is possible to use the substrate D and the resin stamper RS fabricated in the embodiment described above to manufacture a spacer layer SP composed of two or more layers of light transmitting resin. In this case, as shown in FIG. 10, an applied liquid R1 for a light transmitting resin is dripped onto the surface of the resin stamper RS on which the fine protrusion/depression pattern is formed and the applied liquid R1 is applied across the entire surface region of the resin stamper RS by spin coating. Next, the applied liquid R1 is hardened. More specifically, when a UV curable resin is used as the applied liquid R1, the applied liquid R1 is irradiated with UV rays to harden the applied liquid R1. At this time, in accordance with the transfer characteristics from the resin stamper RS described above, the depth Ld01 of the lands LD formed in the spacer layer SP is shallower than the depth DPRS of the fine protrusion/depression pattern of the resin stamper RS. Next, as shown in FIG. 11, the applied liquid R2 for a light transmitting resin is dripped onto the surface of the substrate D on which the recording layer L1 is formed and the applied liquid R2 is applied across the entire surface region of the substrate D by spin coating. Next, as shown in FIG. 12, the applied liquid R1 and the applied liquid R2 are placed in close contact so as to stick the resin stamper RS to the substrate D. More specifically, when a UV-curable light transmitting adhesive resin is used as the applied liquid R2, the applied liquid R2 is irradiated by UV rays from the resin stamper RS side and is hardened to stick the resin stamper RS to the substrate D.

Next, the resin stamper RS is separated from the substrate D. By doing so, as shown in FIG. 13, a spacer layer SP, which is composed of a two-layer resin construction including the applied liquid R1 and the applied liquid R2 and has a fine protrusion/depression pattern of the grooves GR, lands LD, and the like formed (transferred) in a surface of a resin layer composed of the applied liquid R1, is completed. By using this kind of fabrication process, the depth Ld01 of the lands LD of the spacer layer SP and the depth Ld11 of the lands LD of the substrate D are made equal (or approximately equal). According to this fabrication process of the spacer layer SP, it is possible to apply resins with different characteristics to the substrate D and the resin stamper RS. This means that it is possible to use resins that are suitable for the recording layer L1 and the recording layer L0. It should be noted that it is also possible to use a fabrication process in which the applied liquid R2 applied onto the substrate D side is hardened, a UV curable light transmitting adhesive resin is applied onto the resin stamper RS side as the applied liquid R1, and the applied liquid R1 is hardened after the substrate D and the resin stamper RS are placed on one another.

Also, although an example where the respective recording layers L0, L1 are composed using phase-change films has been described in the above embodiment, it is also possible to compose the respective recording layers L0, L1 of write-once recording layers or read-only layers. It is also possible to apply the invention to a part of the DVD family that includes a plurality of recording layers and/or a plurality of read-only layers. Also, in place of the method that uses the first mother stamper MTS1 directly, it is possible to fabricate the substrate D using a metal stamper fabricated by transferring a pattern from the first mother stamper MTS1 an even number of times.

The substrate D is also not limited to a disc-shape, and can be formed in a variety of shapes, such as a rectangle, a polygon, and an oval. Also, in the embodiment of the present invention, an example of a multilayer optical recording medium 1 including two recording layers L1, L0 is described, but the present invention can be effectively applied to a multilayer optical recording medium with three or more recording layers. This multilayer optical recording medium includes a substrate D, which has guide grooves (the grooves GR, lands LD, and the like) for tracking purposes formed on a surface thereof on an incident side for a laser beam, the guide grooves having a recording layer formed on a surface thereof, and also includes two or more light transmitting layers that also have guide grooves (the grooves GR, lands LD, and the like) for tracking purposes formed in surfaces thereof, the guide grooves having other recording layers formed on surfaces thereof, the light transmitting layers being formed above the substrate D, and the respective guide grooves being formed with the same (or approximately the same) depth. Also, there are no particular limitations on the materials of the respective metal stampers and the respective resin stampers, and the materials can be selected as appropriate. Also, although an example of a construction where the recording layer L1 includes a reflective film has been described in the respective embodiments of the present invention, the presence of a reflective film in the recording layer L1 is not essential for the present invention, and the reflectivity and the refractive index of the substrate D and of the respective layers can be appropriately adjusted to produce a multilayer construction where a sufficient amount of reflected light that does not hinder recording and reproduction is obtained when the recording layer L1 reflects a laser beam. Also, although an example that uses a method of forming the cover layer C by spin coating the recording layer L0 with an applied liquid RC for a light transmitting resin and then hardening the applied liquid RC has been described in the above embodiment of the present invention, it is also possible to use a method that forms the cover layer by sticking on a light transmitting resin sheet via a light transmitting adhesive layer. In this case, it is possible to use a polycarbonate resin sheet that is around 50 to 100 μm thick, for example, as the resin sheet and to use a UV curable adhesive, for example, as the light transmitting adhesive layer.

### INDUSTRIAL APPLICABILITY

As described above, according to the method of manufacturing the multilayer optical recording medium, a stamper fabricating process includes at least a process that fabricates a first stamper, which is made of metal and in a surface of which a reversed fine protrusion/depression pattern with a reversed orientation to a protrusion/depression pattern of the guide grooves to be formed in the surfaces of a substrate and a light transmitting layer is formed, and a resin stamper, in whose surface is formed a reversed fine protrusion/depression pattern, the reversed fine protrusion/depression pattern being transferred from a metal stamper in whose surface is formed a fine protrusion/depression pattern with the same orientation as the protrusion/depression pattern of the guide grooves, having a reversed orientation to the guide grooves, having a depth that is deeper than the reversed fine protrusion/depression pattern of the first stamper, and being capable of forming, when the resin stamper is used to form a light transmitting layer, guide grooves of an equal depth or an approximately equal depth to the guide grooves formed in the surface of the substrate in a surface of the light transmitting layer. By respectively forming the substrate and the light transmitting layer using the first stamper and the resin stamper, it is possible to make the depth of the guide grooves in the light transmitting layer and the depth of the guide grooves in the substrate similar, so that it is possible to realize a method of manufacturing a multilayer optical recording medium that can manufacture a multilayer optical recording medium for which a tracking error signal has a favorable S/N ratio during a tracking servo for every recording layer.

1. A method of manufacturing a multilayer optical recording medium that uses a stamper fabricated by a stamper fabricating step to manufacture a multilayer optical recording medium including a substrate that has guide grooves for tracking purposes formed on a surface thereof on an incident side for a laser beam, the guide grooves having a recording layer formed on a surface thereof, and a light transmitting layer that also has guide grooves for tracking purposes formed in a surface thereof, the guide grooves having another recording layer formed on a surface thereof and the light transmitting layer being formed above the substrate,
the stamper fabricating step comprising at least a step of fabricating a first stamper, which is made of metal and in whose surface a reversed fine protrusion/depression pattern with a reversed orientation to a protrusion/depression pattern of the guide grooves is formed, and a resin stamper in whose surface is formed a reversed fine protrusion/depression pattern, the reversed fine protrusion/depression pattern of the resin stamper
being transferred from a metal stamper in whose surface is formed a fine protrusion/depression pattern with the same orientation as the protrusion/depression pattern of the guide grooves,
having a reversed orientation to the guide grooves,
having a depth that is deeper than the reversed fine protrusion/depression pattern of the first stamper, and
being capable of forming, when the resin stamper is used to form the light transmitting layer, guide grooves of an equal depth or an approximately equal depth to the guide grooves formed in the surface of the substrate in a surface of the light transmitting layer, and
the method of manufacturing comprising at least:
as an intermediate step of manufacturing the multilayer optical recording medium, a step of fabricating the substrate, in whose surface the guide grooves are formed by transferring a pattern from the first stamper;
a step of forming the recording layer on the surface of the guide grooves in the fabricated substrate;
a step of applying a light transmitting resin onto the surface of the formed recording layer;
a step of forming the light transmitting layer, in which the guide grooves are formed with an equal or approximately equal depth to the guide grooves formed in the substrate, by transferring a pattern from the resin stamper to the surface of the applied light transmitting resin; and
a step of forming the other recording layer on the surface of the guide grooves in the formed light transmitting layer.

2. A multilayer optical recording medium manufactured in accordance with a method of manufacturing the multilayer optical recording medium according to claim 1, the multilayer optical recording medium including the substrate that has the guide grooves for tracking purposes formed on the surface thereof on the incident side for a laser beam, the guide grooves having the recording layer formed on the surface thereof, and at least one light transmitting layer that also has guide grooves for tracking purposes formed in a surface thereof, the guide grooves having another recording layer formed on a surface thereof and the at least one light transmitting layer being formed above the substrate,
wherein the guide grooves respectively formed in the respective surfaces of the substrate and the light transmitting layer are formed with equal or approximately equal depths.
